(19) United States
(12) Patent Application Publication
(10) Pub. No.: US 2002/0178078 A1
(43) Pub. Date: Nov. 28, 2002

(54) System and method for retaining clients by automated services fulfillment

(76) Inventor: Sean David OToole, Atlanta, GA (US)

Correspondence Address: SEAN O TOOLE, 2106 MARSH TRAIL CIRCLE, ATLANTA, GA, 30328, US

(21) Appl. No.: 10/000,760

(22) Filed: Oct. 24, 2001

Related U.S. Application Data
(60) Provisional application No. 60/242,967, filed on Oct. 24, 2000.

(51) Int. Cl. G06F 17/60

(52) U.S. Cl. 705/26

(57) ABSTRACT

A system and method of combining software and the internet to create a automatic fulfillment system utilizing contact management type databases and direct relationships with third party fulfillment partners to complete the printing and delivery of written correspondence and the purchase and shipment of items and products for delivery. The business process is designed to easily facilitate the commons business practice of timely written client correspondence and the timely sending of personal gifts and other items.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INNENTION

This invention is a process that uses a variety of existing technologies in an order and fashion that currently does not exist to complete many of the marketing and client communication tasks needed in business. The business process uses the internet and our software hosted on a website to gather, store and transmit client contact information in order to fulfill all types of correspondence and gifts and other items for delivery immediately or at specified dates in the future as our user requests. The invention is unique because of the process and method that this information is used to automate a very personalized and timely client retention service through the fulfillment of printed correspondence, gifts, promotional items and other products. It also is unique in the manner and ease of use that a user can submit and complete and order as well as the way the software facilitates the fulfillment. Since the applicable information of the user, the recipient and the vendor is already stored, the software, in conjunction with the internet, eliminates several steps currently used by other businesses and websites to process orders for fulfillment.

A user (defined as a person utilizing the Software to purchase items for delivery) will store their clients (defined as clients of the user and/or recipients of items a user purchases) contact information on a database to be used for the delivery address of the items they choose. The same user will also store their own information for billing and contact information. The user also may store an image of their signature(s), logos or other images for use on their correspondence. Once this information is entered the user does not have to reenter any contact information into the fulfillment system when they want to send a client a signed card, note, letter or gift. Thus eliminating multiple and redundant steps used by businesses to process and ship orders. In this application we refer to an “operator” as an entity that may use the software, through a licensing arrangement to operate business unique to them.

The user also can design and store templates of their stationary, notes and choose or design a template for greeting cards. These templates are used when the user has pre- set that a letter is to go out on a certain date in the future or when the user logs in to the site to send a piece of correspondence. The templates simply are a stored method of telling the printer exactly where to print the ink on the paper when the order is sent for printing.

The user also can choose to have multiple tasks fuilfilled in the future by selecting a “level of service”. The level of service feature is part of the software designed to automatically send, in the fuue, on specified dates that are unique to the users clients any type of printed correspondence or a pre-selected products. When a user enters a new client into the database they also enter key information such as birtldate, anniversary, closing of the sale of a home etc. The higher the level of service the more frequent the contact and the higher the price and quality of the gifts For example; A birthday cake sent to arrive on a birthday, or a thank you card one year from the date of a big sale, A letter requesting an annual review or checkup one year from the last appointment, all entered into the system months ago. Currently there is software and Web sites that can be set up as a reminder service. This is a service that actually completes the task instead of reminding our user of the need to do it.

An additional component of our invention is the fulfillment process. Since the user has already stored their own billing information and the clients shipping information, to send an item, either correspondence or a gift, all they need to do is log in to the site, select the type of correspondence or gift of choice, select the client from their list, enter the message (or revise the message in the template/letter) and click to ship or mail. (Users can use a PC, hand held computer or any other internet enabled device to access the site.) The software gathers all the information needed from the database. This is similar to the patented “one-click” technology that was promoted by “amazon.com” uses but instead is a four (five if a date in the future is selected) click process used to send an order to someone else. This method of four to five clicks to place an order, and the process enabling the complete fulfillment of the order whether the item is completed in house or at a 3^{rd} party's site is unique to this invention.

An additional unique feature of this process is the utilization of multiple vendors to fulfill orders generated from the site. Our software allows gift items from multiple ₃rd party vendors to be displayed and purchased by our users for their clients. The automatic fulfillment that the software enables includes a direct link with the multiple vendors to fulfill their items once ordered from our site. Operators of the software can determine to only use items from their own selection on the site or to use multiple vendors from around the world to offer items for sale The order fulfillment process described in the detailed description section sends the order to the vendor of the product who ships the product.

### PRIOR ART

(a) Direct Mail

Currently there are direct mail firms that send all types of product advertisement to past clients or prospects. There are marketing firms that provide data on what features or products customers have used in the past and direct their marketing efforts to those people and their past purchases. Our process lets the user customize each letter to the specific recipient and deliver the letter on a specific day, unique to the recipient rather than a mass mailing.

(b) Greeting Card Stores

There are online greeting card companies that let users write, buy and send greeting cards to anyone. Some sites allow for a reminder service to email a user and remind them that they wanted to send a card. Some allow for an email greeting to be sent at a date in the fuiture. Our process is automated and relieves the user of a reminder or returning to the site to begin an order. Our process also allows a much more personalized message including an image of signature and a logo from the sender printed on the card.

(c) Webbased Reminder Service

There are several Web-based reminder services used by many Web sites where you can enter some general information and ask to be reminded by email of a specific event in the future. This email then contains a link to bring the user back to a Web site so they can shop for a gift. This process eliminates this step and fully automates the purchase and billing to the user.

I.e. www.rememberit.com

(d) Web Based and other Printing Companies

There are printing companies that allow a user to have their material printed and sent to mailing lists. These sites allow a user to upload or create forms, letters brochures etc. and then upload or create a mailing list. This invention allows the user to send one piece or multiple pieces immediately or at a time in the fuiture.

I.e. www.eletter.com

(e) Web Based Gift Stores

There are gift and shopping sites where a user can go to search for a gift, select the gift they want and then enter delivery information and add a note to the gift. The invention removes several steps from the order process by storing both the user and clients' delivery information. The invention also takes a further action by enabling the commingling multiple product vendors on the site. The software can be used as a single company catalogue or enable many vendors to list products with the same efficiency.

I.e. www.send.com

(f) Contact Magement Software

There are contact management software programs that people use to enter contact information and then schedule “tos” tit will show in a calendar at a date in the flture.. These allow the upload and transfering of Client data. The invention works with these software programs. Rather than being notified that a to-do is pending, the invention fulfills that task relating to correspondence or gift type items. The user will see a calendar on the site detailing what is being done rather than what needs to be done. These software programs also enable the user to create a template for a printed correspondence then select a client, select the template and the two are merged and matched in to word processing software on the users computer. The user then completes the letter, prints it and manually prepares the document for mailing. The invention takes the user's manual portion out of the process as well as allowing the user to send that document at a later date.

I.e. ACT 2000!, Goldmine, MS Outlook

The invention we have created compiles many of the useful features of these past ideas into a complete webbased software tool that automates the fulfillment of printed correspondence and the delivery of items. The software automates a process that more efficiently solves current methods of web-based commerce.

### BRIEF SUMMARY OF THE INVENTION

A Web site is the initial entry point for this invention although the software will work on an intranet. A user will come to the site and enter through a personal login consisting of a user name and password. Initially they will enter their own information including address, contact phone numbers and email address as well as their credit card and other billing information. This is how they get a user name and password. They will also upload their logos, image of their signature and other images used in their own corporate or personal correspondence.

The user will then have several options of entering their client's contact information which as a minimum will consist of their full name, address, phone number and have several database fields to enter specific dates such as birthday, anniversary of opening an account, graduation etc. This data can be entered by an upload from a database type file or entered individually on our Web site. This information is stored on a database such as Access, MS Sequel or Oracle so the data can be manipulated both by the user and our business.

The user then either uploads or creates on the site their own format for Birthday Cards, Notes and form letters or newsletters with which they will use to send to their clients. These templates are stored on the server and only available to the user. The user is also provided with pre-set greeting cards and templates for their use as well. Users may upload their corporate logos, pictures or nearly any image to use on their correspondence. These images are added to the correspondence while previewing the note or letter and then again when in the background our software creates a file to send to print.

Next the user can select a level of service for each client that determines when a card, note, letter or gift will be sent in the future on a specific date. The “level of service” feature of the site is one advantage of the invention and solves the existing problem of many current methods of delivering items in the future. This unique feature eliminates the need for reminders and a return to the site. Users simply select a client, trigger the service level by filling in a button in a table, and the service triggered is fulfilled in time to reach the destination on the date the user has entered for that specific client. There is no need for the user to return to the site or for the vendor to keep a paper list or electronic reminder list. The process we invented stores the data and creates an order at the appropriate time. The higher the level of service the more expensive and more often an item of correspondence is sent The user can use a recommended set of items or flilly customize what and when they would like something sent. These “level of service” tables are inclusive of both printed co ondence and gift type items.

Our software is partially triggered by dates. When triggered it then retrieves both the users information as well as the clients information, creates a file using the pre-set template and text entered by the user previously. The file also includes the users return address, the recipients address and the type of medium to print on. The file is sent to a printer and/or a 3^{rd} party where it is printed and mailed to the client. So if a user selects a service of birthday card for Client A, on the date the user has entered for client A's birthday (or a few days before to accommodate mailing time) our software automatically matches the key data fields, generates a birthday card for client A, sends the order to the printer where the card, message and signature and/or logo for the user is printed on the card and envelope. This method eliminates the user returning to the site and then beginning an order process. The tasks the user has set for ftlfillment are displayed on a calendar on the site when they log in. The user also receives a monthly email alerting them to what is planned to be sent out on their behalf If it needs to be altered the user simply clicks on the item on the calendar and changes the information there.

The software and process also can send gifts on a predetermined date. If the user has selected a “level of service” that designates a gift be sent in the tuture, or just choose a client to send an product to, a similar process of retrieving the shipping information for the recipient is pulled, the user is billed using their already stored information, and the shipping information is sent to the distributor of the gift. The distributor then sends the gift. The process of fulfilling multiple tasks in the future by selecting a “level of service” or specifying to order product for delivery on a date in the future using this software process described is a claim of this patent. Specifically the business method designed to automatically send, in the future, on specified dates that are unique to the users clients any type of printed correspondence or pre-selected products.

The method of fulfillment of orders is a new and unique process that minimizes the users time and re-entry of data. When the user logins in to the site using their name and password their database is immediately available. To buy and ship a gift to a client is 4 click (5 if a future date is selected) process once the gift is selected:

1. Once the gift is chosen from a selection the user clicks to select that item.

2. Select the client of choice to send the item to. Select the name in a drop down box or alphabetized list it to from his or her own database on the site.

A picture of the item, written description and text box screen appears. The user types in their message in this text box or modifies the suggested message that is made available to them.

3. Click to send to this client. A detailed order summary appears

4. If a fixtre date is desired the user will enter the date next.

5. Click to confirm order. The software processes the order. If the billing is verified the order is sent.

This method of four to five clicks to place an order, and the process enabling the complete fulfillment of the order whether the item is completed in house or at a ₃rd party's site is unique to our invention and one of the claims to this patent In addition the method of fulfilling a product order triggered by a date inclusive of retrieving database information of the user, client and vendor, billing the user and sending an order to the vendor is a claim of this patent This method solves many of the problems that exist on current web-based sites that require the user to enter multiple data fields to complete the order. The software and business process does the rest as described below.

(a) To send a piece of correspondence

The user clicks to the page “Send a (letter, Card,..) Which is where the word processor type software resides. The user chooses which template or item they want and type a message in the text box on the site. The user chooses the recipient from a pull down box on the page listing all of the clients in their database. The user chooses which one of their signatures they want to add to the message and clicks preview to see the message, as it will look after print. The software matches what was entered in the text box and displays a preview of the printed image with the users signature.

If the user is satisfied they click “send now”. That initiates a software process of creating a file containing the image to print on the correspondence, which type and size of paper to user, the recipients address for printing on the envelope. This file is batched with others like it and sent to a printing company or local printing machinery to print the message and the envelope. Postage is then affixed and the correspondence is mailed. The invention is automated and relieves the user of a reminder or returning to the site to begin an order. Our process also allows a much more personalized message including an image of signature and a logo from the sender printed on the card.

(b) To send a gift

Using the method described above the software then bills the user using the stored credit card information, then takes the recipient information and the text for the message and sends an order to the vendor of that item. The Vendor prints the message on their note card or with a printer and note cards we have at their distribution point and ships the product to the recipient The operator of the service pays the vendor bills. The software works with other current credit card processing software to bill the user at the time of the order.

In order to add product to the site, the vendor of the item, or the operator, enters the complete description of the item as well as all the necessary detail of what information is needed to purchase the item from them. This data is stored in the database for use when ordering. The operator of the software can use all products from their own creation, 3^{rd} party items or any combination. These items when entered in the database are displayed on the gift offering section of the site, complete with description and price.

All gifts listed on the site must be negotiated and approved with the vendor. The software sends the order to that vendor in a predetermined acceptable format. Some vendors will get a direct data trnnsfer using XML language; some will receive an email while others may get a fax depending on their preference. The billing is charged to the operator by the vendor and operator charges the user before the order is sent. The user will get an invoice and be able to track the shipping on the operator's web site.

This method of adding products from multiple ₃rd party vendors to be displayed and purchased by our users for their clients accompanied by the automatic fulfillment that the software enables by a direct link with the vendor to fulfill an item once ordered from our site is a unique new process that will help people easily identify and purchase a variety of items.

(c) Tracking the Gift

Our service is designed for professionals in varying lines of business that will use gifts and mailings as part of their sales cycle or relationship building activities. Therefore it is important that the delivery of the gift has impact. We notify our users when the gift has been delivered.

Our site and technology is designed so that when the recipient signs for the package (when shipped UPS or FedEx) and the delivery service keys in to there handheld computer that the gift has been delivered; that information is pulled by our software, from the senders web-based service, matched with the sender. The site then sends an email is to our user/sender of the gift notifying them that it has been received.

This gives our users the benefit of knowing exactly when the gift has been received and allows them to take any action they see fit.

### BRIEF DESCRIPTION OF THE DRAWINGS

FIG. 1 is a block diagram illustrating the finctional page layout for a Web site constructed in accordance with an exemplary embodiment of the present invention.

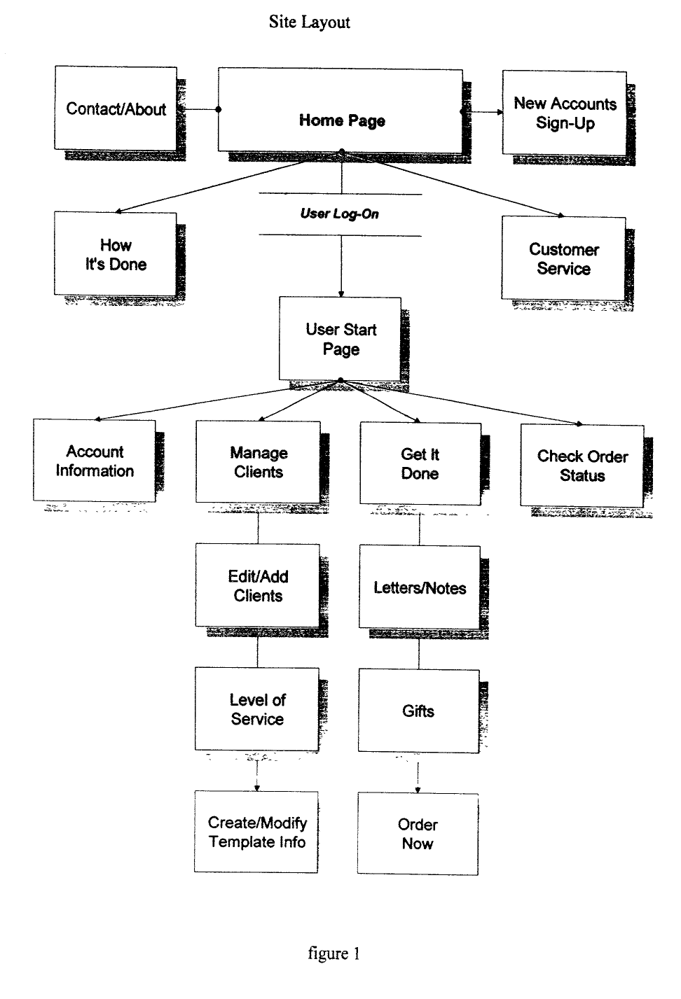

FIG. 2 is a logical flowchart diagram illustrating a process for entering user information and completing initial set up in accordance with an exemplary embodiment of the present invention.

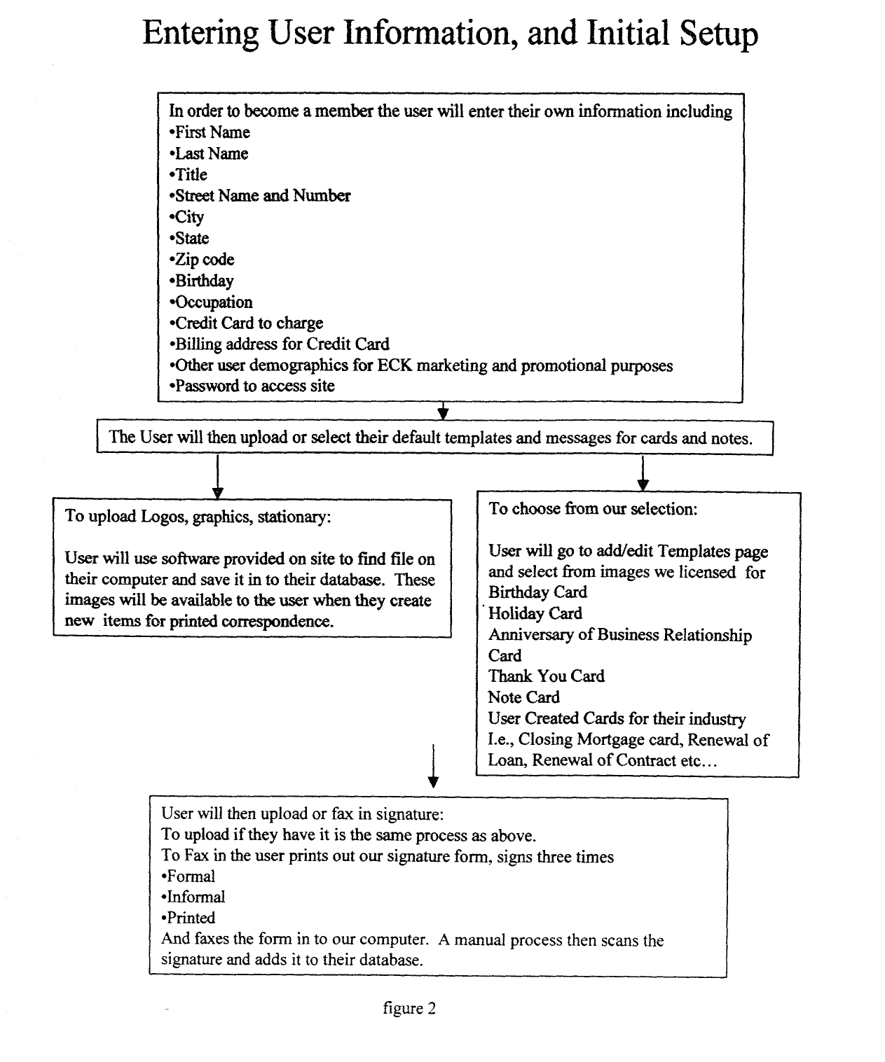

FIG. 3 is a logical flowchart diagram for a process for entering client information in accordance with an exemplary embodiment of the present invention.

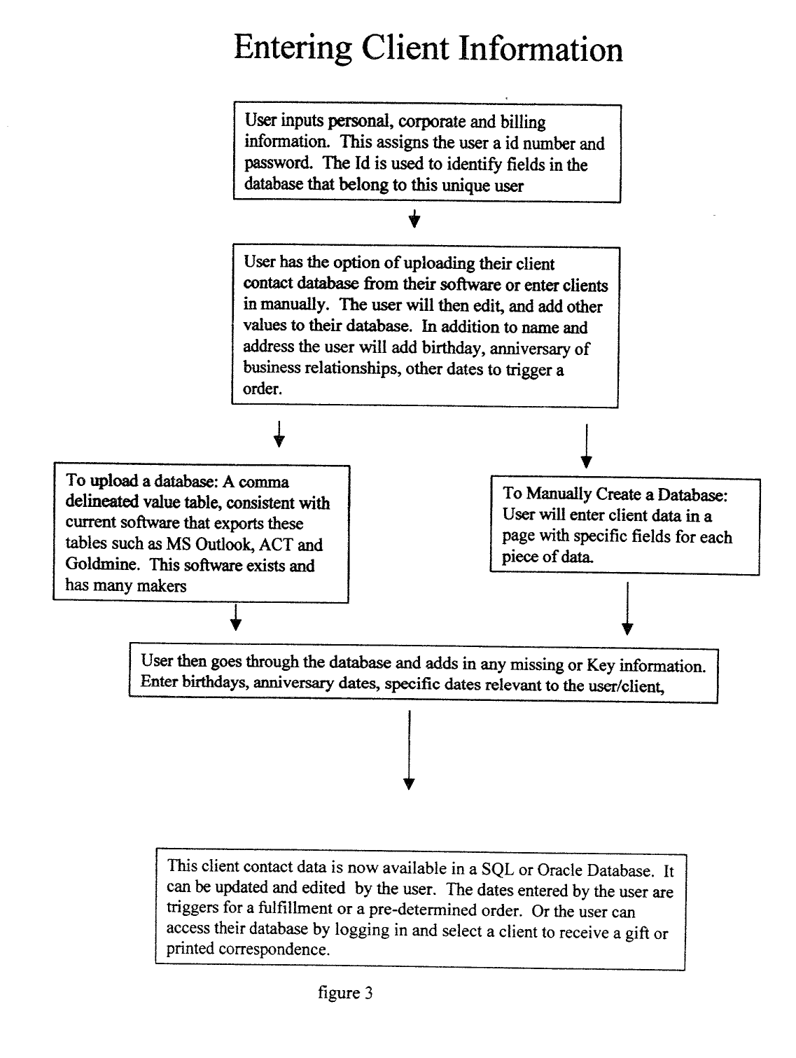

FIG. 4 is a logical flowchart diagram illusing a process for choosing a level of service for clients in accordance with an exemplary embodiment of the present invention.

FIG. 5 is a logical flowchart diagram illustrating a process for ondemand gift fulfillment in accordance with an exemplary embodiment of the present invention.

FIG. 6 is a flowchart diagram illustrating a process for completing on-demand thank you correspondence in accordance with an exemplary embodiment of the present invention.

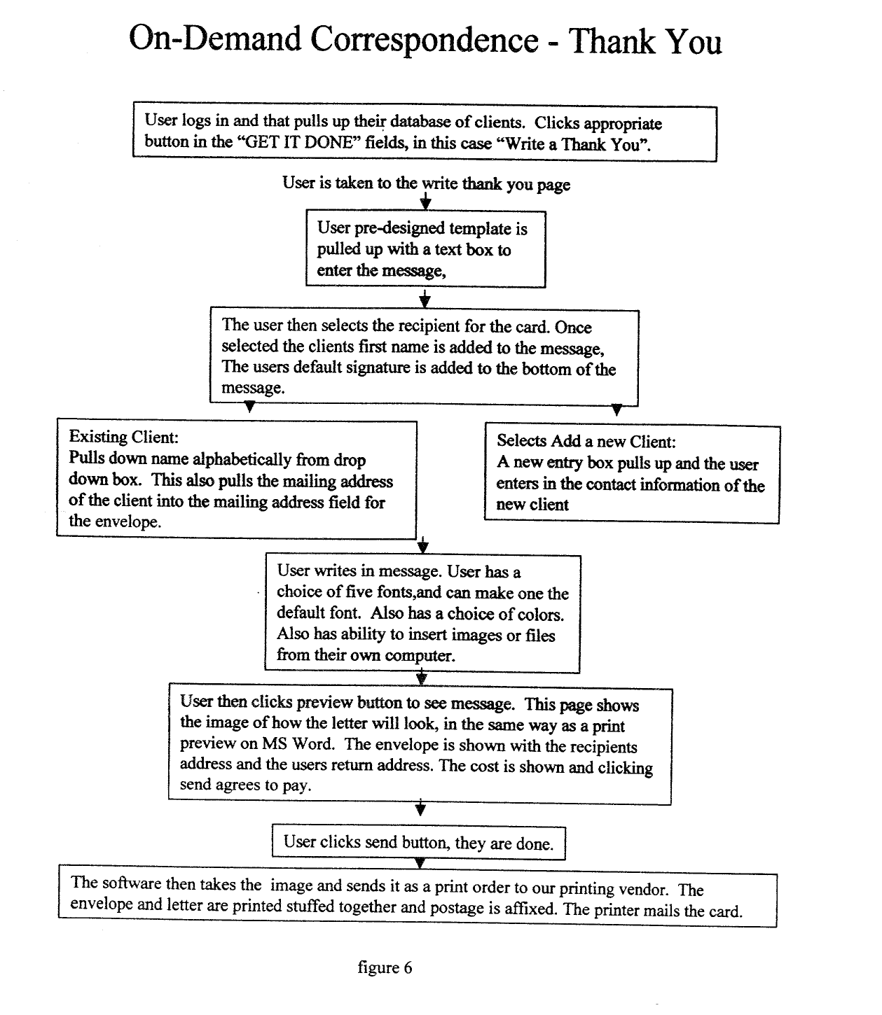

FIG. 7 is a flowchart diagram of a process for completing on-demand correspondence in accordance with an exemplary embodiment of the present invention.

FIG. 8 is a logical flowchart diagram of a process for automatic fuilfillment of printed correspondence in response to a date trigger event in accordance with an exemplary embodiment of the present invention.

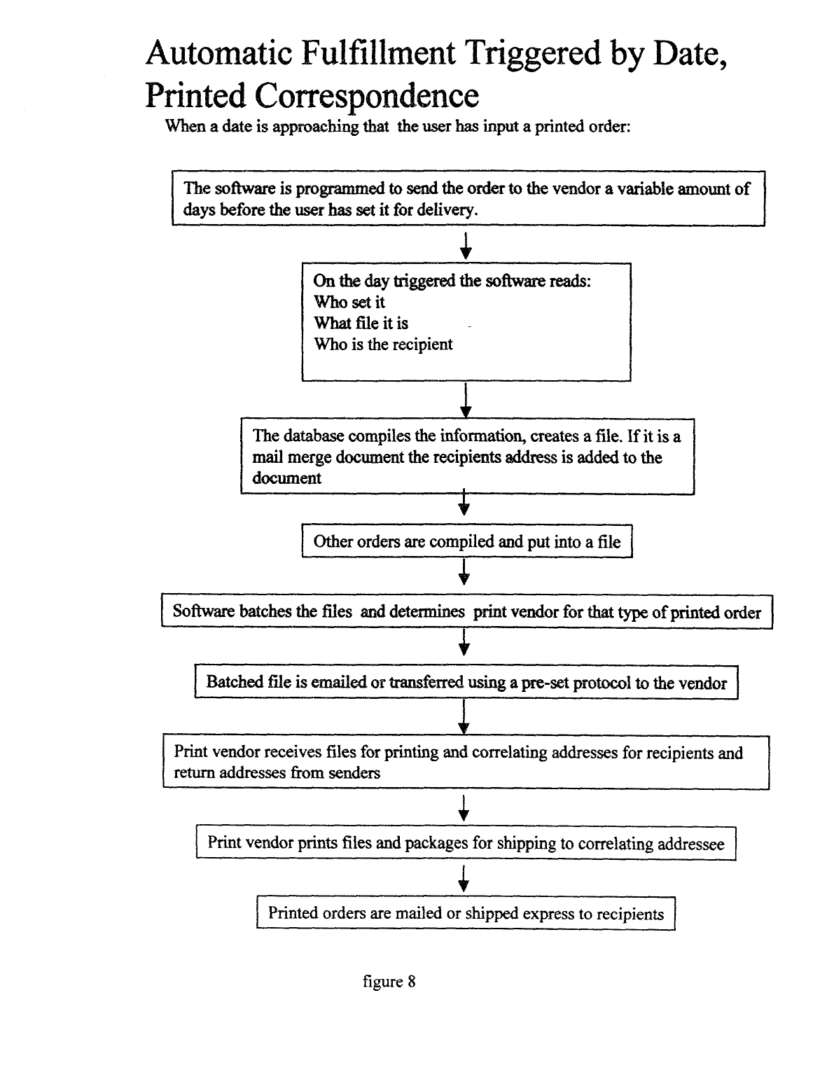

FIG. 9 is a logical flowchart diagram illustrating a process for automatic fulfilment of a gift in response to a date trigger event in accordance with an exemplary embodiment of the present invention.

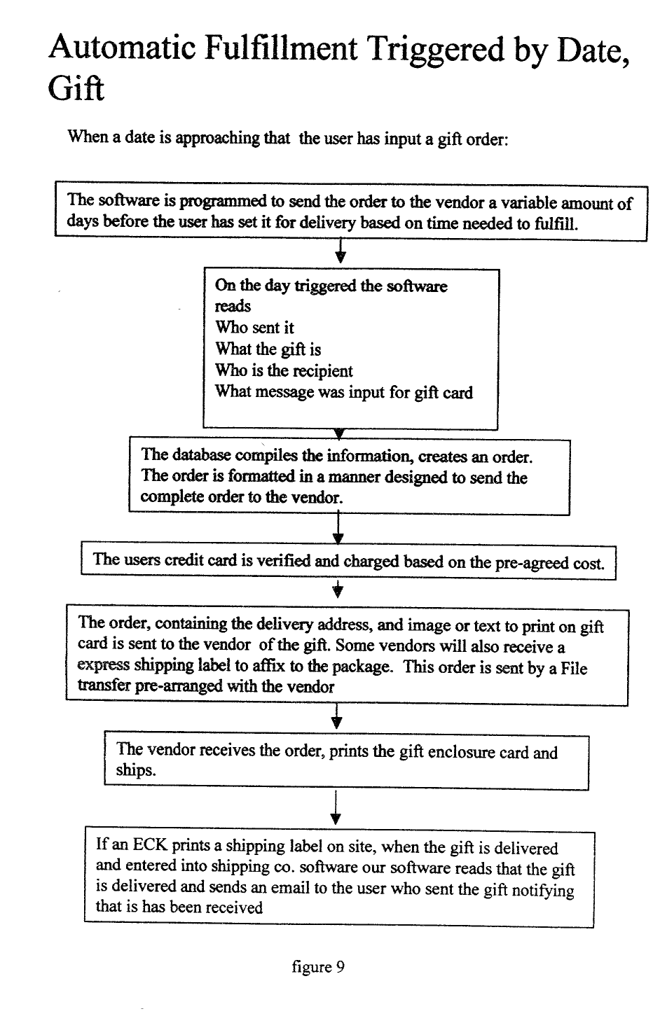

FIG. 10 is a logical flowchart diagram illustrating a process for creating an automatic fulffilment by date in accordance with an exemplary embodiment of the present invention.

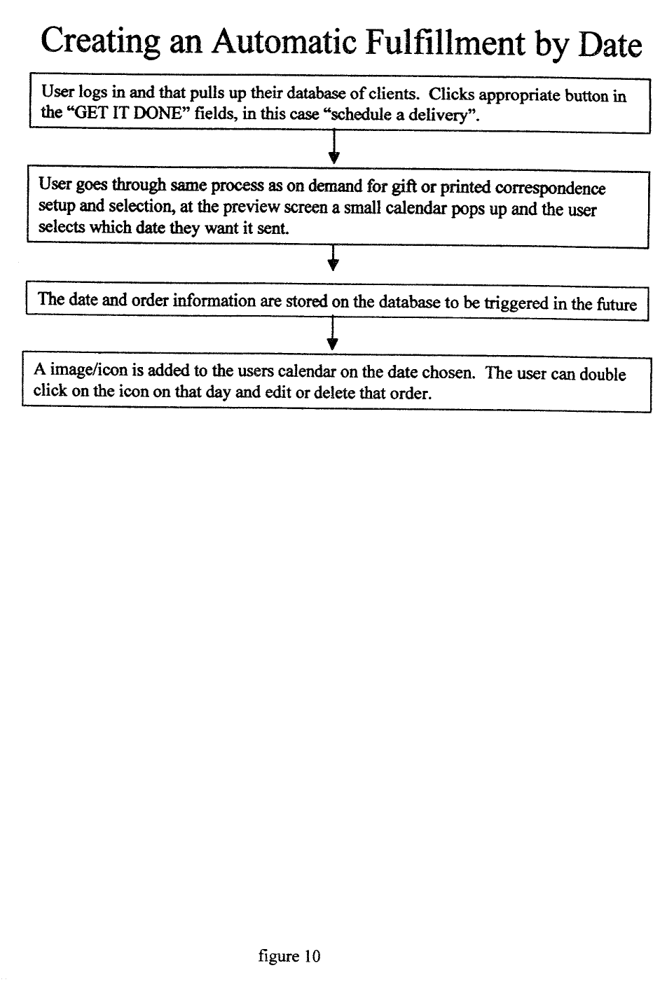

FIG. 11 is a logical flowchart diagram for creating a template in accordance with an exemplary embodiment of the present invention.

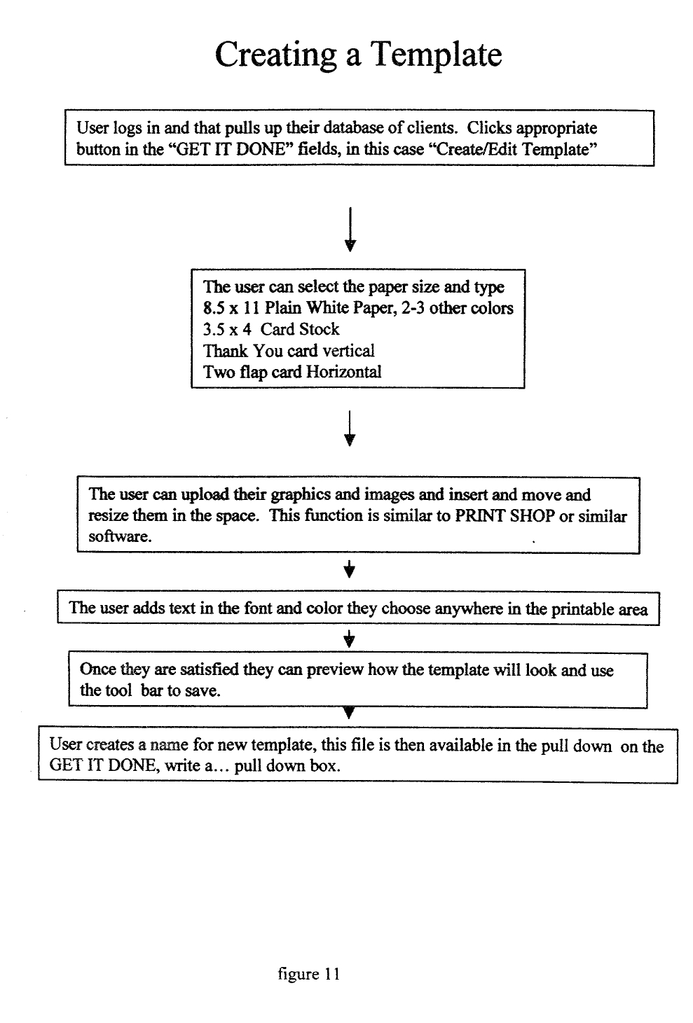

FIG. 12 is a logical flowchart diagram illustrating a process for responding to an electronic mail message for monthly fulfillment items in accordance with an exemplary embodiment of the present invention.

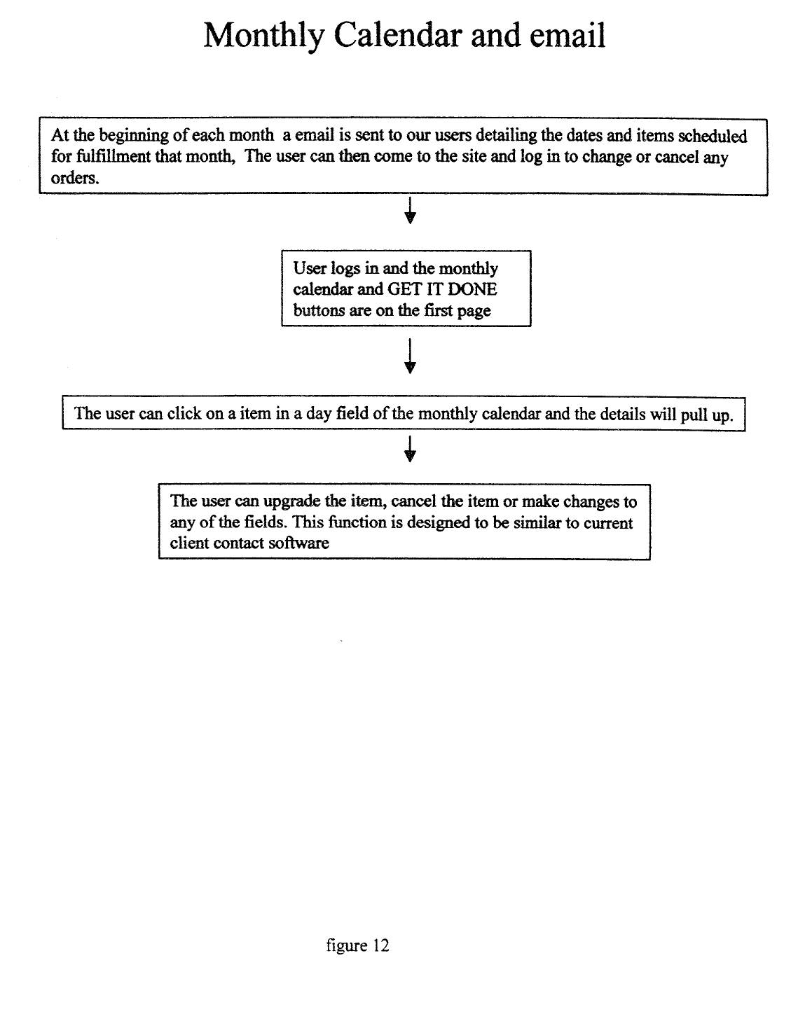

FIG. 13 is a logical flowchart diagram illustrating a process for completing batch orders for print in accordance with an exemplary embodiment of the present invention.

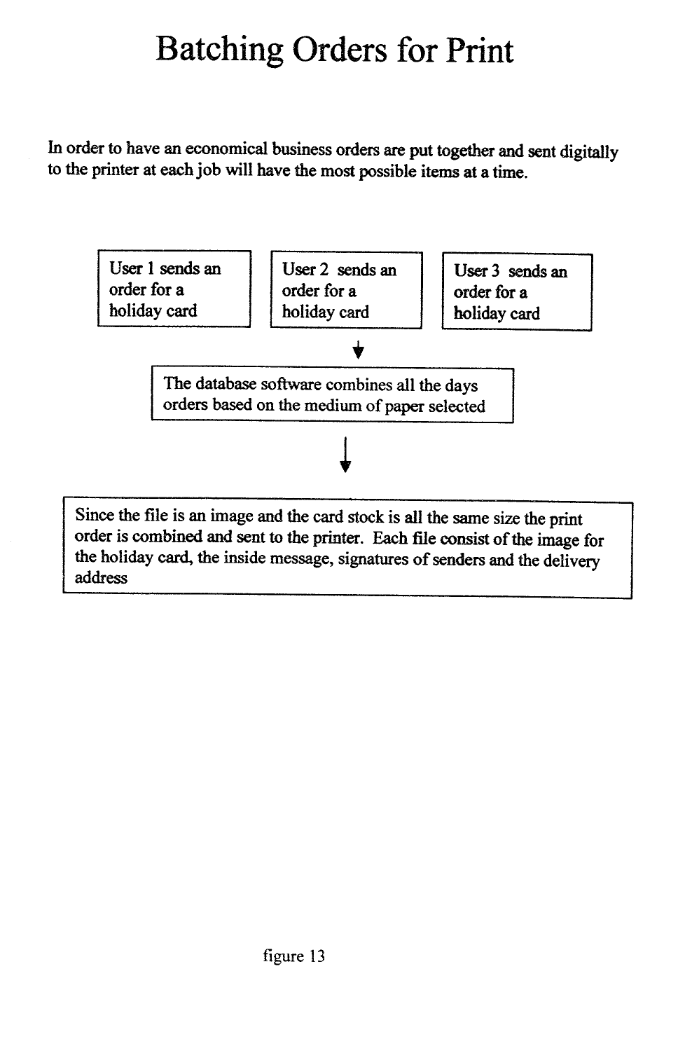

### DETAILED DESCRIPTION OF THE EXEMPLARY EMBODIMENTS

Using a Web site designed using mainly Active Server Pages the user enters with a personal login common to many Web sites. The log in triggers our software to identify who has logged in and what data to bring forward to the screen. Each user will have their personal data displayed on a standardized format on their screen after log in. This enables the site to be used immediately. The personal data is maintained on a larger database, currently Microsoft Access but will also work with SQL and others. The personal data has fields that distinguish which user has logged in and what data to pull from the database and display on the web page.

The login page of the user consists of a news or messages to the user and several buttons for accomplishing tasks. It is designed so that the user can immediately accomplish a task. These buttons are linked to the corresponding page on the website.

The data for both the user and their clients are stored in database software like Microsoft Sequel or Access. Our site can manipulate this data to search for activities that are scheduled for fulfillment. The user can enter the information through a standard Web type entry system or upload a comma delineated database, an excel spreadsheet or a .dbf file in a specific format Using other licensed software, or our own, the user can also hot- sync and upload their data from a contact management software or a hand held computer. This technology is available from multiple vendors.

The process of using the website to create, print and mail a items of personal correspondence complete with a unique message and signature for delivery in the works in the following manner. The site enables the design and storage of templates for a variety of correspondence similar to a page set-up and template screen commonly used by work processing software. The templates are fixed areas corresponding to a known size and shape of a medium for the correspondence like a card or 8½×11′ paper. The templates are simply a format for where to place the data pulled from a database on the corresponding medium. Much like the familiar “page setup” on most software programs tell the software and printer where to put the ink on the page. It is the data that determines what color, font, size etc goes on the medium. This data is passed to the printer during the process.

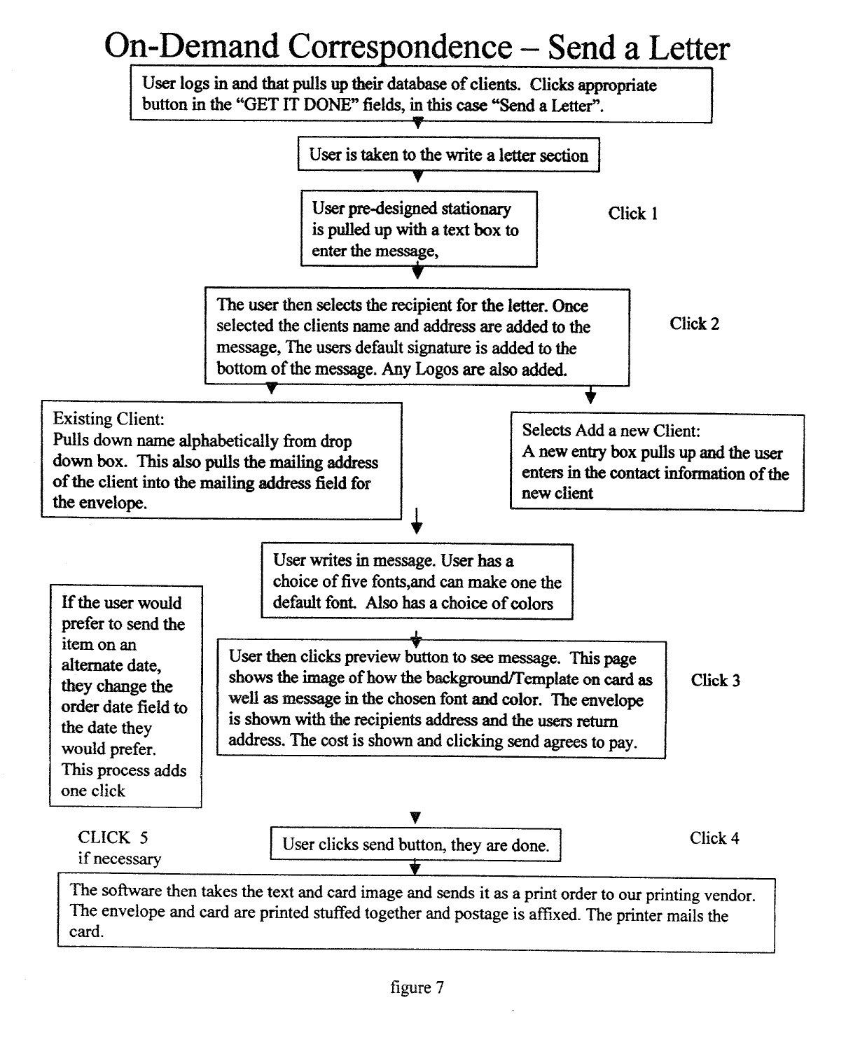

Users of the software/website will follow a path described in FIG. 7. Once logged in the software only will access that user's information. The User's personal return address, image of the signature and logos are available at this time. When the “send a letter” button is clicked the user is taken to the corresponding page. The user has a choice of using a pull down box to select a recipient in their database or add a new recipient The user may also elect to fill in the text box with an existing letter already stored as a data field in their database. A text box is displayed for the user to type a message. This text box transmits the information to a field in the database, displayed as a larger open area for the user to type in. The user then by filling in or clicking on a radio button may select to add their signature. This action tells the software to insert the image of their signature in the letter in the formatted location on the template. The user then selects the date on which they want it sent. This date is added to the database corresponding to the text entered and the other corresponding fields.

When our software searches the database and shows that an item is set for delivery it begins the process of fulfilling the order. First the user's credit card is charged or pended for the cost of the letter. If approved the process begins. The template is found, the text stored in a field in the database is matched to the correct area in the template, the image for logos or signatures are added to the correct location on the page. and the software sends the order for print. The order is printed on the appropriate medium (cards, letter, flier). This is done using existing software modified to work within our Web site. The actual machines for printing are printers and printing machines commonly used by printing companies. We have several methods to fulfill the print order depending on the type of correspondence.

1. In house Printers

2. Send to Printing Company

3. Print at the DistributorNendor site

4. Send order to a WebBased printer

All of which simply receive the data, fill the machine with the appropriate medium and print. Two data feeds are sent for each piece of correspondence. A file for the text on the medium and a file for the text on the envelope.

The Web site/software is also capable of printing and mailing multiple pieces of correspondence with one order. In the process above the user will select multiple clients to receive the letter instead of only one. The software simply cycles through the process ifor each recipient when triggered. The Web site can also be used for direct mail to prospects.

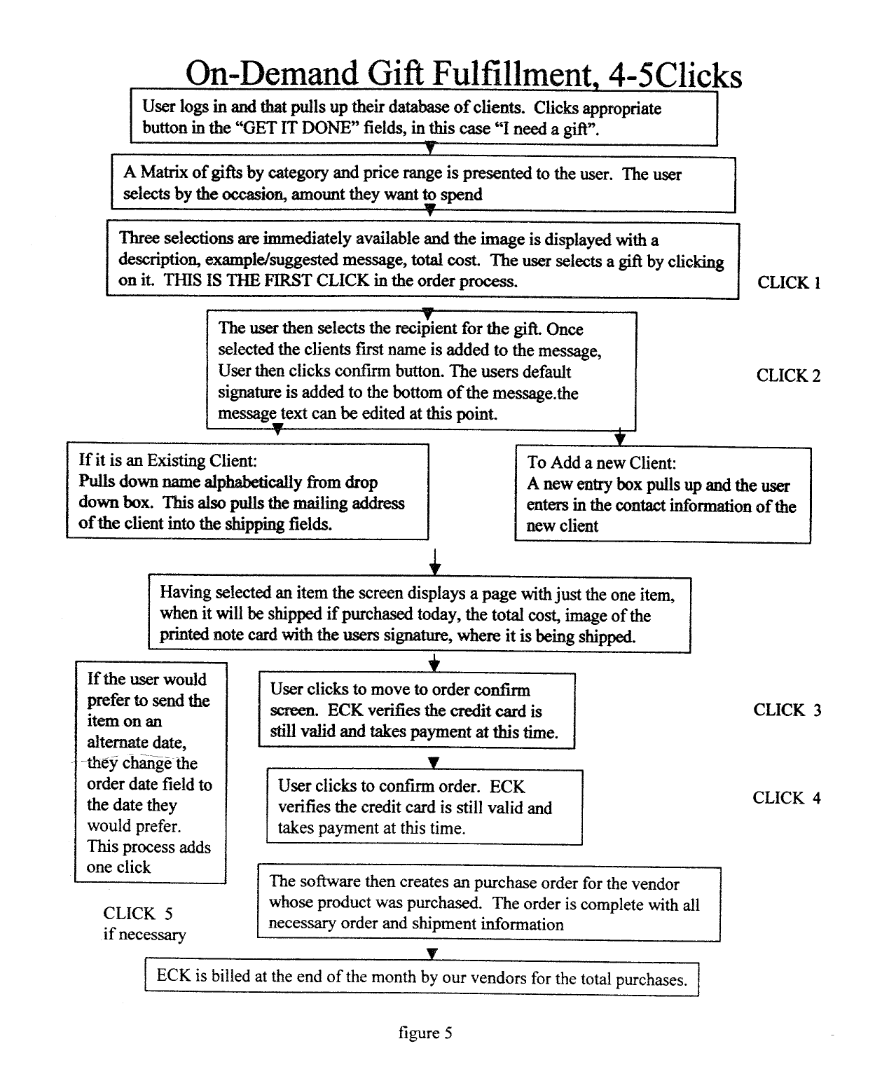

The method of four to five clicks to place an order, and the process enabling the complete fulfillment of the order whether the item is completed in house or at a ₃rd party's site is unique to our invention and one of the claims to this patent. The process to accomplish these claims is detailed below and shown in FIG. 5.

To order a product to send to the users client or other recipient the user goes to the site and uses a 4click technology/system to get it done.

User logs on, this tells the software which user screen to display and which data the user has access to. The user clicks the “send a gift” button and is transferred to a page showing a matrix of gift items by category and price range. The user selects the button corresponding to the type of gift and desired price range. This moves the user to a page with gift items displayed by picture and a short summary of the product.

To buy and ship a gift to a client is 4-click (5 if a future date is selected) process once the gift is selected:

1. Once the gift is chosen from a selection the user clicks to select that item.

This action will create a new page for the user with the necessary fields and steps to complete the order.

2. Select the client of choice to send the item to. Select the name in a drop down box or alphabetized list it to from his or her own database on the site. By selecting the name the recipients' information is added to the order screen.

A picture of the item, written description and text box screen appears is on this page as well. The user types in their message in this text box or modifies the suggested message that is made available to them.

3. Click to send to this client. A detailed order summary appears by pulling the recipient's information from the database pulls the users credit card information and is ready to create an order. If a future date is desired the user will enter the date next.

4. Click to confirm order. The software processes the order. If the billing is verified the order is sent to a vendor complete with the recipient's information, the users return address, the message to print on the enclosure card. This order is sent to the vendor by email, fax or XML data tansfer depending on the vendor.

We charge the users credit card for the order as the price shown for the item. Once it is confirmed that the charge went through the order is processed for fulfillment. This method of fuilfilling a product order can be independently triggered by a date that the user has entered. The added step of specifying a date in the order entry process will put the order on hold until that date arrives. The gifts have been identified and listed specifically to enable a more personalized note or template to automatically show in the message box. These gifts also when selected determine how the gift enclosure card is to be printed. For example, if the gift is a bottle of wine, the automatic gift card could be printed with a image of the wine valley where the wine was produced. If the gift is a set of golf balls, the card could be printed with a picture of a golf course. The user has the option of using these cards or their own from their templates and have multiple ways to select gifts. Users can select gifts by buttons signifying type of gift or price range or a combination of both. When a button is clicked, a new page with a picture of the items, a description of each and a text box for a message is presented. The user will select an item, fill in or edit the message in the text box and click the send now button to confirm the order. Each button is a hyperlink to the next step in the process.

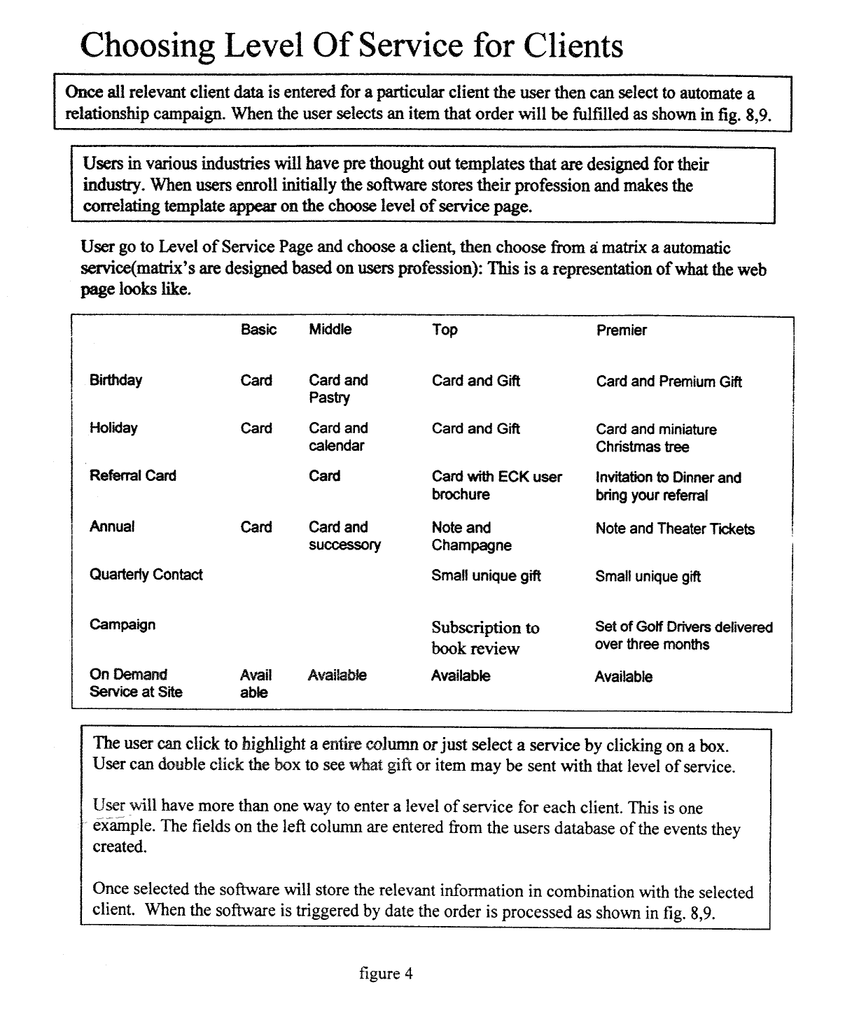

The process of fulfilling multiple tasks in the future by selecting a “level of service” or specifying to order product for delivery on a date in the future using this software process described is a claim of this patent. Specifically the business method designed to automatically send, in the fiiure, on specified dates that are unique to the users' clients any type of printed correspondence or pre-selected products. This is fijer described below and on FIG. 4.

(a) The Level of Service Feature

Once a new client is entered the ECK user will select a level of automated personalized service for that particular client. See example below in Table I.

TABLE I
Choose Service Level

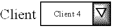

| | | | |
|---|---|---|---|
| Basic | Middle | Top | Premier |

Birthday

| | | | | | | | |
|---|---|---|---|---|---|---|---|
| 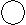 | Card | 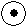 | Card and Pastry | 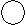 | Card and Gift | 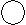 | Card and Premium Gift |

Holiday

| | | | | | | | |
|---|---|---|---|---|---|---|---|
| 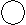 | Card | 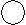 | Card and Calendar | 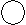 | Card and Gift | 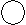 | Card and Mini Tree |

Referral Card

| | | | | | |
|---|---|---|---|---|---|
| 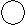 | Card | 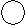 | Card w/ECK user brochure | 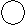 | Invitation to Dinner (Bring referral) |

Annual

| | | | | | | | |
|---|---|---|---|---|---|---|---|
| 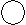 | Card | 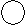 | Card and accessory | 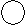 | Note and Champagne | 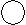 | Note and Theater Tickets |

Quarterly Contact

| | | | |
|---|---|---|---|
| 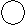 | Small Unique Gift | 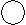 | Small Unique Gift |

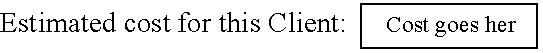

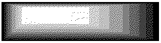

The client is then enrolled and when the dates are near the software triggers the fulfillment of the order. This level is stored with each client in the database

Example: A birthday is five days away. Since the user has entered the birth date for the client into the database and selected a level of service where a card is sent out to arrive to the specific client on their specific day. The software when triggered by the day begins the creation and printing of a card through a similar method as described to create a piece of correspondence.

The method of adding products from multiple ₃rd party vendors to be displayed and purchased by our users for their clients accompanied by the automatic fulfillment that the software enables by a direct link with the vendor to fdfill an item once ordered from our site is a claim of this patent.

In order to add product to the site, the vendor of the item, or the operator, logs in to a special section of the web site. They enter through the use of a user name and password and are given access to a web page where they enter the complete description of the item as well as all the necessary detail of what information is needed to purchase the item from them. This data is stored in the database for use when ordering. The operator of the software can use all products from their own creation, 3^{rd} party items or any combination These items, when entered in the database, are displayed on the gift offering section of the site, complete with description and price. These data fields are used to by the software to fill in the details on the item on the gift matrix. The software to generate the order and submit it to the vendor also uses these fields.

All gifts listed on the site must be negotiated and approved with the vendor. The software sends the order to that vendor in a predetermined acceptable format. Some vendors will get a direct data transfer using XML language; some will receive an email while others may get a fax depending on their preference. The billing is charged to the operator by the vendor and operator charges the user before the order is sent. The user will get an invoice and be able to track the shipping on the operators' web site.

### Appendix A

### Software for New User Information Gathering and Initial Setup

Web Hosting Software

On Server Stores and retrieves files

Internet Search Engine

Software Accesses files

And displays Site

Database Software

Captures and Stores new users personal

And business information

File Transfer Software:

Uploads files from PC

And stores in database

Word Processor Software

To edit or create documents, uses a mail merge fimction that extracts data from users databs

Imaging Software:

Captures signatures from fax's

To store in database

Credit Card Processing Software

Verifies credit and charges user

Programming:

Creates and Stores User Name and Password

Allows access to user

### Software for New User Information Gathering and Initial Setup

Programming

Provides a fill in the box form to add a new client and access edit existing clients.

Syncing Software

That can work with other contact management databases to convert client information into the ECK

Format and database.

Calendaring Software

Creates and displays a calendar populated with the users events and clients key dates.

Programming

Searches though databases for dates and orders to initiate the fulfillment of an order

Programming

Searches though databases for key dates with no orders and sends emtail alert to user notifying of

the event and that nothing is set up

### Software for Creation of Templates

Word processing Software

Users can save files on ECK site

Uses a mail merge function for mailing service

Retrieves documents on ECK site or in users computer

Can display preview of item before sending to print and mail

Drawing and Graphic Software

Users can save files on ECK site

Uses a mail merge function for mailing service

Retrieves documents on ECK site or in users computer

Can display preview of item before sending to print and mail

Desktop Publishing Software

Users can save files on ECK site

Uses a mail merge function for mailing service

Retrieves documents on ECK site or in users computer

Can display preview of item before sending to print and mail

Software that creates file compatible for commercial printing

Takes users files from software programs and converts to a stadard image

that can be sent directly to print at vendors print site

### Software for Choosing and implementing Automated Service

Table Display with Active fields created by our software:

A table of services for an automated campaign is displayed. The gifts and items on the table are

populated by the software determined by the users industry or preference

Each item has a field for the user to select (turn on)

When selected, the item (gift or print piece) is associated with the active client and creates and

order for fulfillment in the future.

The software reads the users database and verifies that the order can be completed.

Any necessary information to complete the order that is not already in the database is asked for by

a pop up window.

Once the user is done selecting the service and order verification is complete the orders are put in

database for fulfillment in the date requested.

### Software for sending orders to vendors for fulfillment

Database Management

Software searches database and order database for pending orders. When an order is due for

fulfillment:

Determine which vendor fulfills the order and:

Printed Correspondence:

Orders are batched based on the medium they are printed on and sent as one file to vendor

for printing and direct mail.

Gifts:

Each order is sent to vendor with complete information

1. The process of fuilfilling multiple tasks of the printing and delivery of correspondence or the purchase of items on dates that are unique to a users individual client by means of a “level of service” as described in this application.

2. The business method designed to automatically send, in the future, on specified dates that are unique to the users clients any type of printed correspondence or pre-selected products.

3. The method of fulfilling an product order triggered by a date inclusive of retrieving database information of the user, client and vendor, billing the user and sending a order to the vendor.

4. This method of four to five clicks to place an order, and the process enabling the complete fulfillment of the order whether the item is completed in house or at a ₃rd party's site.

5. The invention of using the website to create, print and mail a items of personal correspondence complete with a unique message and signature for delivery in the future is one to the claims of this patent.

6. The method of adding products from multiple ₃rd party vendors to be displayed and purchased by our users for their clients accompanied by the automatic fulfillment that the software enables by a direct link with the vendor to fulfill a item once ordered.
